(19) United States
(12) Patent Application Publication
(10) Pub. No.: US 2020/0224809 A1
(43) Pub. Date: Jul. 16, 2020

(54) PIPE COUPLING

(71) Applicant: Western Oilfields Supply Co., Bakersfield, CA (US)

(72) Inventor: John W. Lake, Bakersfield, CA (US)

(21) Appl. No.: 16/667,112

(22) Filed: Oct. 29, 2019

Related U.S. Application Data
(60) Provisional application No. 62/792,651, filed on Jan. 15, 2019.

(51) Int. Cl. F16L 37/248; B05B 15/65

(52) U.S. Cl. CPC F16L 37/248; B05B 15/65

(57) ABSTRACT

A pipe coupling assembly may include a male coupling component including a tubular member having a retaining ring projecting radially from, and extending around a portion of the circumference of the tubular member. A female coupling component may include a body having a bore with a first end sized to slidingly receive the first end of the tubular member. An O-ring may be at least partially received in a radial groove formed in a side wall of the bore, and may be sized to sealingly engage an exterior of the tubular member when the tubular member is received within the bore. The body may also include a retaining pad extending outwardly relative to the bore, and spaced from the first end of the bore to define a channel between a first end of the body and the retaining pad that is sized to at least partially receive the retaining ring.

### CROSS-REFERENCE TO RELATED APPLICATIONS

This application claims the benefit of U.S. provisional patent application Ser. No. 62/792,651, filed 15 Jan. 2019, entitled “Apparatus and Method for a Twist Lock Coupling,” the entire disclosure of which is incorporated herein by reference.

### TECHNICAL FIELD

The present disclosure generally relates to coupling systems for fluid carrying pipes, and more particularly relates to coupling systems that provide locking connections between sections of fluid carrying pipes.

### BACKGROUND

Often fluid conveyance systems require multiple individual segments of piping to achieve the desired objective. Accordingly, it is often necessary to provide joints between individual pieces of piping or tubing. Joints between individual pieces of piping may use a variety of connections, such as threaded connection, compression joints, and the like. Such connection may be challenging to effectuate in a fluid tight manner, and/or may be difficult to connect or disconnect. Accordingly, more efficient and easier to use fluid connections are desirable.

### SUMMARY

According to an implementation, a pipe coupling assembly may include a male coupling component including a tubular member having a first end and a retaining ring spaced from the first end. The retaining ring may project radially from the tubular member and may extend around a portion of the circumference of the tubular member. A female coupling component may include a body having a bore extending through the body. A first end of the bore may be sized to slidingly receive the first end of the tubular member. The body may further include a radial groove formed in a side wall of the bore spaced from the first end of the body. An O-ring may be at least partially received in the groove. The O-ring may be sized to sealingly engage an exterior of the tubular member when the tubular member is received within the bore. The female coupling component may further include a retaining pad extending outwardly relative to the bore, and spaced from the first end of the bore to define a channel between a first end of the body and the retaining pad. The channel may be sized to at least partially receive the retaining ring of the male coupling component.

One or more of the following features may be included. One or more of the first end of the tubular member and the bore of the body include a chamfer to facilitate insertion of the tubular member into the bore. The body may further include a backstop ring defining a diameter less than an outside diameter of the tubular member to resist insertion of the tubular member into the bore beyond the backstop ring.

The tubular member may be insertable into the bore of the body when the retaining ring is in a first angular orientation relative to the retaining pad. The retaining ring may be at least partially received in the channel in a second angular orientation of the retaining ring relative to the retaining pad. Interaction of the retaining ring and the retaining pad may resist removal of the tubular member from the bore. The retaining ring may include one or more support gussets extending between a forward face of the retaining ring and the exterior of the tubular member.

The tubular member further include a second end longitudinally opposed to the first end. The second end may be configured to be coupled with a fluid pipe. The second end of the tubular member may include a bore having an inside diameter configured to receive an end of a pipe section. The body may further include a second end longitudinally opposed to the first end. The second end may be configured to be coupled with a fluid pipe. The second end of the body may include a bore having an inside diameter configured to receive an end of a pipe section.

The body may include a sled feature extending between a first end of the body and a second end of the body. The sled feature may be upturned at at least one of the first end of the body and the second end of the body. The sled feature may include a curved shape between the first end of the body and the second end of the body. The body may include a threaded bushing in fluid communication with the bore and extending radially outwardly relative to the bore. The threaded bushing may be cast into the body.

According to another implementation, a method of coupling at least two pipe segments may include providing a first pipe segment coupled at one end to a male coupling component. The male coupling component may include a tubular member having a first end and a retaining ring spaced from the first end. The retaining ring may project radially from the tubular member and may extend around a portion of the circumference of the tubular member. The method may also include providing a second pipe segment coupled at one end to a female coupling component. The female coupling component may include a body having a bore extending through the body. A first end of the bore may be sized to slidingly receive the first end of the tubular member. A radial groove may be formed in a side wall of the bore spaced from the first end of the body. An O-ring may be at least partially received in the groove. The O-ring may be sized to sealingly engage an exterior of the tubular member when the tubular member is received within the bore. The female coupling component may also include a retaining pad extending outwardly relative to the bore, and spaced from the first end of the bore to define a channel between a first end of the body and the retaining pad. The channel may be sized to at least partially receive the retaining ring of the male coupling component. The method may also include orienting the first pipe segment relative to the second pipe segment to position the retaining ring out of alignment with the retaining pad. The method may also include inserting the male coupling component at least partially into the bore of the female coupling component to sealingly engage the exterior of the tubular member with the O-ring. The method may further include rotating the first pipe segment and the second pipe segment relative to one another to at least partially align the retaining ring and the retaining pad to position the retaining ring at least partially within the channel.

One or more of the following features may be included. Inserting the male coupling component at least partially into the bore of the female coupling component may include inserting the tubular member into the bore until the first end of the tubular member contacts a backstop ring within the bore. The backstop ring may define a diameter less than an outside diameter of the tubular member. The pipe segments may include irrigation pipe segments. Rotating the first pipe segment and the second pipe segment relative to one another to at least partially align the retaining ring and the retaining pad to position the retaining ring at least partially within the channel couples the first pipe segment and the second pipe segment. Inserting the male coupling component at least partially into the bore of the female coupling component may include orienting one or more of the first pipe segment and the second pipe segment generally parallel with a surface at least partially supporting one or more of the first pipe segment and the second pipe segment. Inserting the male coupling component at least partially into the bore of the female coupling component may include orienting one or more of the first pipe segment and the second pipe segment at an angle relative to the surface at least partially supporting one or more of the first pipe segment and the second pipe segment.

The female coupling component may include a sprinkler riser extending therefrom. Inserting the male coupling component at least partially into the bore of the female coupling component may include orienting the sprinkler riser generally parallel to a surface supporting at least a portion of the second pipe segment. Rotating the first pipe segment and the second pipe segment relative to one another may include one or more of rotating the first pipe segment in a clockwise direction, rotating the first pipe segment in a counterclockwise direction, rotating the second pipe segment in a clockwise direction, and rotating the second pipe segment in a counterclockwise direction. The method may further include positioning the coupled first pipe segment and second pipe segment in a desired location by dragging one of the first pipe segment and the second pipe segment. An interaction between the retaining ring and the retaining pad may resist separation of the first pipe segment and the second pipe segment. The body may include a sled feature extending between a first end of the body and a second end of the body, the sled feature being upturned at at least one of the first end of the body and the second end of the body. The sled feature may reduce intrusion of dirt into the bore of the body. The sled feature may include a curved shape between the first end of the body and the second end of the body.

### BRIEF DESCRIPTION OF THE DRAWINGS

FIG. 1 is a front isometric view of an example female coupling component with an example O-ring gasket and cast-in threaded bushing that may be used in one or more example implementations of the present disclosure;

FIG. 2 is an example rear isometric view of an example female coupling component with an O-ring gasket and cast-in threaded bushing that may be used in one or more example implementations of the present disclosure;

FIG. 3 is an example front isometric view of an example male coupling component that may be used in one or more example implementations of the present disclosure;

FIG. 4 is an example rear isometric view of an example male coupling component that may be used in one or more example implementations of the present disclosure;

FIG. 5 is an example side cross-section view of an example coupling assembly as the male coupling component is angled for initial insertion in one or more example implementations of the present disclosure;

FIG. 6 is an example isometric view of an example male coupling component fully seated in an example female coupling component, prior to rotation according to one or more example implementations of the present disclosure;

FIG. 7 is an example cross-section view of the example coupling assembly in FIG. 6, showing the retaining ring on the male coupling component in the unlocked position according to one or more example implementations of the present disclosure;

FIG. 8 is an example isometric view of an example male coupling component fully seated in an example female coupling component, after rotation into the fully locked position according to one or more example implementations of the present disclosure;

FIG. 9 is an example cross-section view of an example coupling assembly in FIG. 8, showing an example retaining ring on the male coupling component in the locked position according to one or more example implementations of the present disclosure;

FIG. 10 is an example side cross-section view of an example coupling assembly in its final locked position according to one or more example implementations of the present disclosure;

FIG. 11 is an example side profile view of an example coupling assembly showing the curvature of the sled feature according to one or more example implementations of the present disclosure;

FIG. 12 is detailed view of an example female coupling component according to one or more example implementations of the present disclosure; and

FIG. 13 is an example general representation of an irrigation pipe assembly with a lateral piping and a riser with sprinkler at each coupling connection according to one or more example implementations of the present disclosure.

### DETAILED DESCRIPTION

The present disclosure generally provides a coupling system and method for fluid conduits, such as pipes, tubes, or the like. In general, the coupling system may include a male coupling component and a female coupling component that may be releasably coupled to one another at a first respective end to provide a generally fluid-tight connection for conveying fluid through the coupling assembly. Respective fluid conduits, such as pipes, tubes, hoses, etc., may joined to the male and female coupling components at a second respective end. Accordingly, the fluid conduits may be coupled to one another by way of the coupling assembly to allow fluid transfer along the fluid conduits and through the coupling assembly. In some embodiments herein the coupling assembly may be described in the context of a coupling assembly for irrigation piping, however, it will be appreciated that the disclosed coupling assembly may be used in connection with numerous additional and/or alternative fluid conveyance systems for both liquid and gaseous fluids.

According to an illustrative example embodiment, a pipe coupling assembly may include a male coupling component including a tubular member having a first end and a retaining ring spaced from the first end. The retaining ring may project radially from the tubular member and may extend around a portion of the circumference of the tubular member. A female coupling component may include a body having a bore extending through the body. A first end of the bore may be sized to slidingly receive the first end of the tubular member. The body may further include a radial groove formed in a side wall of the bore spaced from the first end of the body. An O-ring may be at least partially received in the groove. The O-ring may be sized to sealingly engage an exterior of the tubular member when the tubular member is received within the bore. The female coupling component may further include a retaining pad extending outwardly relative to the bore, and spaced from the first end of the bore to define a channel between a first end of the body and the retaining pad. The channel may be sized to at least partially receive the retaining ring of the male coupling component.

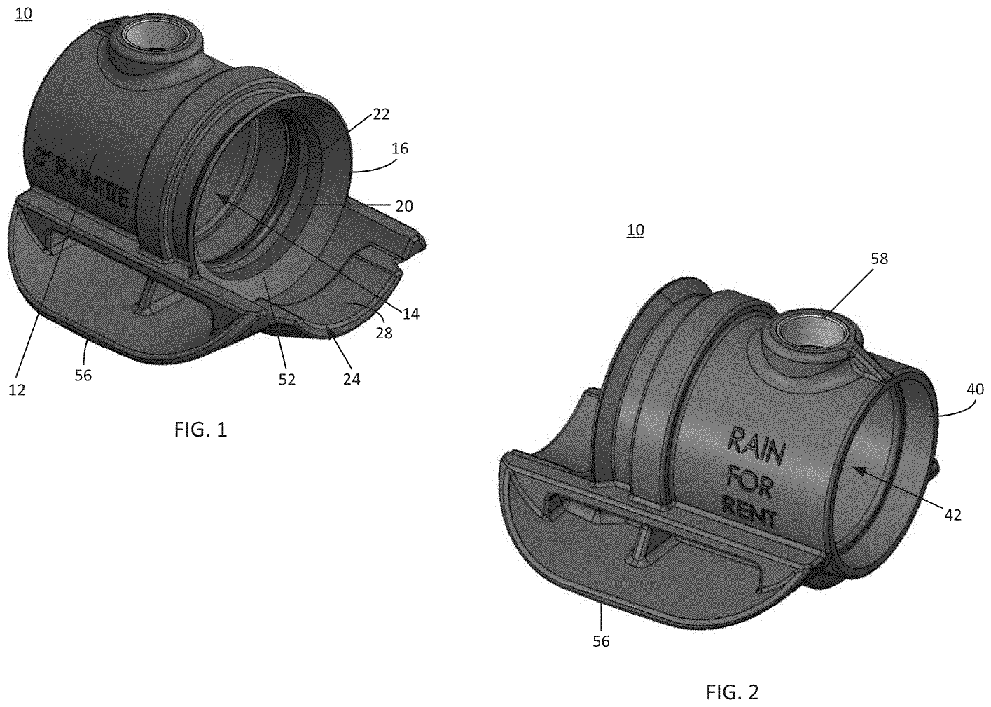

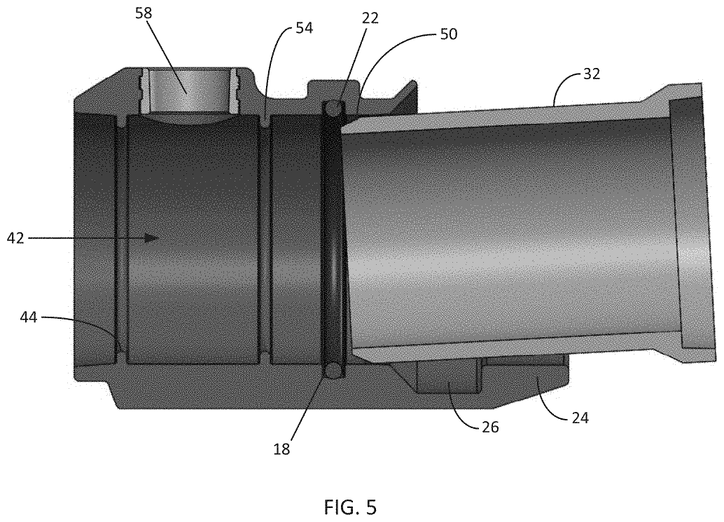

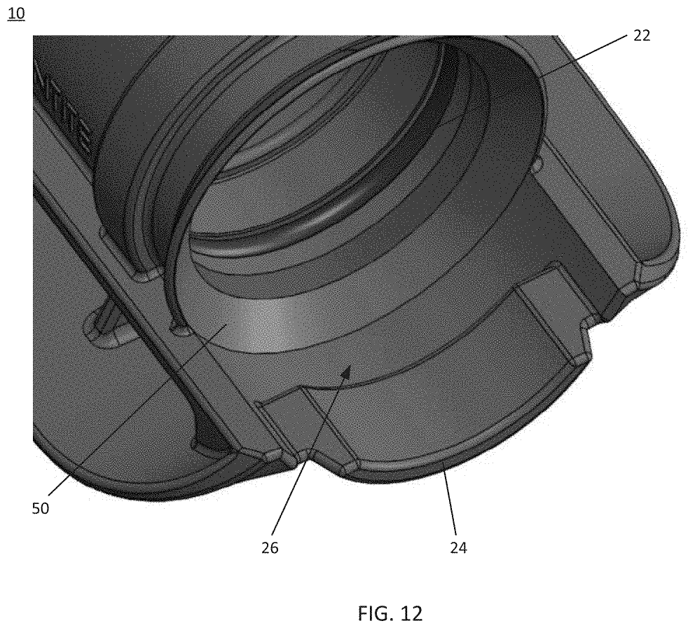

For example, and referring to FIGS. 1 and 2 and 12, an illustrative example embodiment of a female coupling component 10 is shown. In general, the female coupling component 10 may include a body 12 having a bore 14 extending through the body. A first end 16 of the bore 14 may be sized to slidingly receive a first end of a tubular member of a male coupling component (described below). The body 12 may further include a radial groove 18 (e.g., as shown in FIG. 5) formed in a side wall 20 of the bore 18 spaced inwardly from the first end 16 of the body 12. The groove 18 may have any variety of cross-sectional profiles (e.g., round, oval, square, rectangular, trapezoidal, polygonal, etc.), and may generally be formed continuously around the inner circumference of the bore 14. An O-ring 22 may be at least partially received in the groove 18. That is, for example, the O-ring 22 may be partially disposed within the groove 18 (e.g., to longitudinally retain position of the O-ring 22 within the bore 14), and may partially extend into the interior of the bore 14 (e.g., to allow for sealing engagement with the tubular member of the male coupling component). As described in further detail below, the O-ring may be sized to sealingly engage an exterior of the tubular member when the tubular member is received within the bore. The O-ring may be formed from any suitable material, such as vulcanized rubber, silicone, a natural and/or synthetic elastic material, or the like. Additionally, while an O-ring (e.g., a generally annular seal having a circular cross-section) has been shown, it will be appreciated that other seal configurations may suitably be utilized, for example which may be at least partially disposed within the groove in the bore and partially extending into the bore to allow for sealing engagement with the tubular member of the male coupling component.

The female coupling component may further include a retaining pad 24 extending outwardly relative to the bore, 14 and spaced from the first end 16 of the bore 14 to define a channel 26 (best seen in FIG. 5) between a first end 16 of the body 12 and the retaining pad 24. Consistent with some illustrative example embodiments, the retaining pad 24 may have a generally curved land 28. The generally curved land may have a diameter that may be generally similar to the diameter of the bore. Further, in some embodiments, the retaining pad 24 may radially encompass an arc of about 180 degrees or less. In some particular embodiments, the retaining pad may radially encompass an arc of about 110 degrees or less, e.g., to facilitate a 90 degree locking rotation, as described below. However, it will be appreciated that the retaining pad may encompass other angular arcs, including, for example, about 30 degrees, etc.

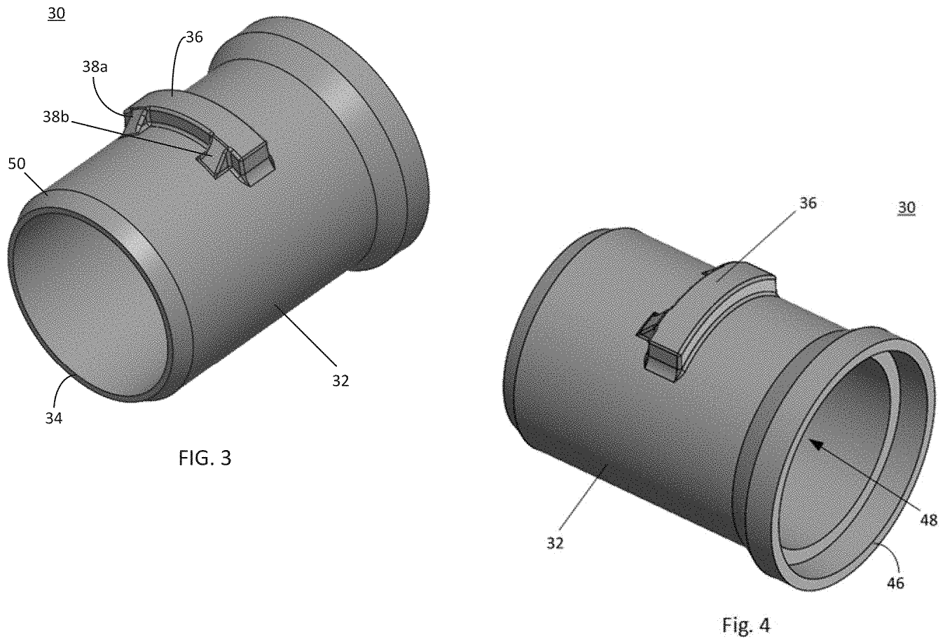

Referring to FIGS. 3 and 4, an illustrative example embodiment of a male coupling component 30 is generally depicted. As shown, the male coupling component 30 may generally include a tubular member 32 having a first end 34. The male coupling component 30 may further include a retaining ring 36 spaced inwardly along the tubular member 32 from the first end 34. The retaining ring 36 may generally project radially from the tubular member 32 and may extend around a portion of the circumference of the tubular member 32. For example, as generally shown, the retaining ring 36 may include an upstanding feature from the exterior of the tubular member 32 that may extend around a portion of the circumference of the tubular member 32. Consistent with an example embodiment, the retaining ring 36 may include a generally perpendicular profile relative to the exterior of the tubular member 32 facing away from the first end 34. Further, in some embodiments, the retaining ring 36 may include one or more reinforcing gussets 38a, 38b, e.g., which may strengthen and/or rigidify the retaining ring 36, extending between a forward face (e.g., facing toward the first end 34) of the retaining ring and the exterior of the tubular member 32. In some embodiments, the retaining ring 36 may radially encompass an arc of about 180 degrees or less along the exterior of the tubular member. In some particular embodiments, the retaining ring may radially encompass an arc of about 70 degrees or less, e.g., to facilitate a 90 degree locking rotation, as described below. However, it will be appreciated that the retaining ring may encompass other angular arcs, including, for example, about 30 degrees, etc.

Consistent with some embodiments, the coupling assembly may be used in connection with a fluid conveyance system. Consistent with such an embodiment, one or both of the female coupling component and the male coupling component may be configured to be joined to a pipe, tube, hose, etc. Accordingly, one, or both, of the female coupling component and the male coupling component may include features to facilitate connection to a pipe. For example, in an illustrative example embodiment in which the female coupling component is configured to be connected with a pipe, the body 12 may further include a second end 40 longitudinally opposed to the first end 16. The second end 40 may be configured to be coupled with a fluid pipe. In a particular embodiment, the second end 40 of the body 12 may include a bore 42 having an inside diameter configured for receiving an end of a pipe section. Accordingly, to connect the female coupling component with the pipe section, the end of the pipe section may be at least partially inserted into the bore 42. In some embodiments, the diameter of the bore 42 may be generally the same as the diameter of the bore 14. In other embodiments, the diameter of the bore 42 may be greater or less than the diameter of bore 14. In some embodiments, the bore 42 may include a stop 44 (e.g., as shown in FIG. 5), which may define an insertion depth for the pipe end being connected to the female coupling component. The stop 44 may be continuous, intermittent, or located at only a single point within the bore 42 to define the insertion depth. In a similar manner, in some illustrative example embodiments, the tubular member 30 further include a second end 46 longitudinally opposed to the first end 34. The second end 46 may be configured to be coupled with a fluid pipe. In an illustrative example embodiment, the second end 46 of the tubular member 30 may include a bore 48 having an inside diameter approximately configured to receive an end of a pipe section. Accordingly, to connect the male coupling component with a pipe section, the end of the pipe section may be inserted into the bore 48. In some embodiments, the diameter of the bore 48 adjacent the second end 46 may be greater than the inside diameter of the bore 48 further inward relative to the second end. As such, an end of a pipe section may only be inserted into the bore 48 at the greater diameter, with the smaller diameter further within the bore 48 defining a stop, which may define an insertion depth for the end of the pipe section being connected to the male coupling component. Consistent with various embodiments, a wide array of techniques may be used for connecting a pipe section with either the female coupling component and/or the male coupling component, such as welding, adhesive bonding, threaded mating, etc. As such, the present disclosure should not be limited to any particular connection technique.

Consistent with the foregoing illustrative example embodiments of the female coupling component and the male coupling component, the coupling assembly of the present disclosure may allow for releasable coupling of the female coupling component and the male coupling component to provide a generally fluid-tight connection that may resist unintentional disconnection. For example, and referring to FIGS. 5 through 10 an illustrative example process for coupling the female coupling component and the male coupling component is generally shown. Consistent with the foregoing description, the retaining pad may define a diameter segment that may be smaller than the diameter of provided by the retaining ring. As described above, each of the retaining pad and the retaining ring may define an arc less than about 180 degrees. For example, in an illustrative example embodiment, each of the retaining pad and the retaining ring may define an arc of about 110 degrees or less. Consistent with such an embodiment, the tubular member 32 may be insertable into the bore 14 of the body 12 when the retaining ring 36 is in a first angular orientation relative to the retaining pad 24, such that the retaining ring 36 is angularly offset from the retaining pad 24. Accordingly, during assembly, the male coupling component 30 (and/or a pipe segment including the male coupling component) may be generally oriented relative to the female coupling component (and/or a pipe segment including the female coupling component) to position the retaining ring 36 out of alignment with the retaining pad 24.

Once the coupling components (and/or pipe segments including the respective coupling components) are oriented to place the retaining ring 36 angularly offset from the retaining pad 24, the tubular member 32 of the male coupling component may be at least partially inserted into the bore 14 of the female coupling component to sealingly engage the exterior of the tubular member 32 with the O-ring 18. Consistent with some embodiments, one or more of the first end 34 of the tubular member 32 and the bore 14 of the body 12 may include a chamfer (e.g., respective chamfers 50, 52) to facilitate insertion of the tubular member into the bore, as shown in FIG. 5. In an illustrative example embodiment, the chamfer angle be between about 2 degrees to about 5 degrees. However, any suitable chamfer angle may be utilized. Further, the chamfer angle 50 on the tubular member 30 may be different than the chamfer angle at the entrance of the bore 14.

Consistent with an illustrative example embodiment, the body 12 may include a backstop ring 54, as shown in FIG. 5. The backstop ring 54 may generally define a diameter less than the diameter less than an outside diameter of the tubular member 32. As such, the backstop ring 54 may resist insertion of the tubular member 32 into the bore 14 beyond the backstop ring 54. It will be appreciated that in various embodiments, the backstop ring 54 may include a continuous ring within the interior of the bore 14, an intermittent ring within the interior of the bore 14, and/or one or more individual protrusions into the interior of the bore 14, which may be sufficient to limit the extent of the insertion of the tubular member 32 into the bore 14. Accordingly, consistent with such an embodiment, inserting the male coupling component at least partially into the bore of the female coupling component may include inserting the tubular member into the bore until the first end of the tubular member contacts a backstop ring within the bore.

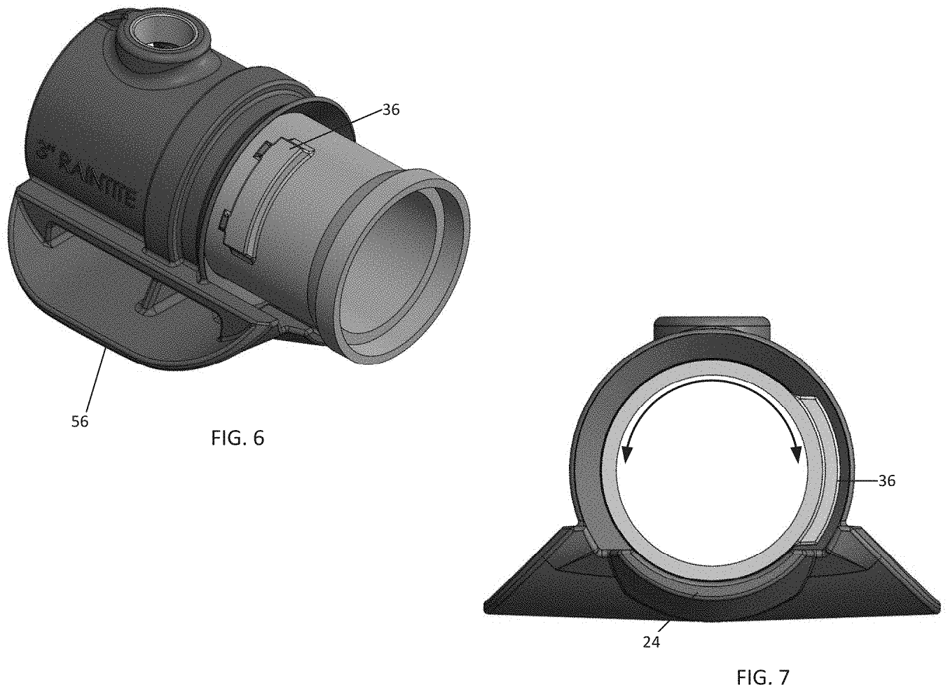

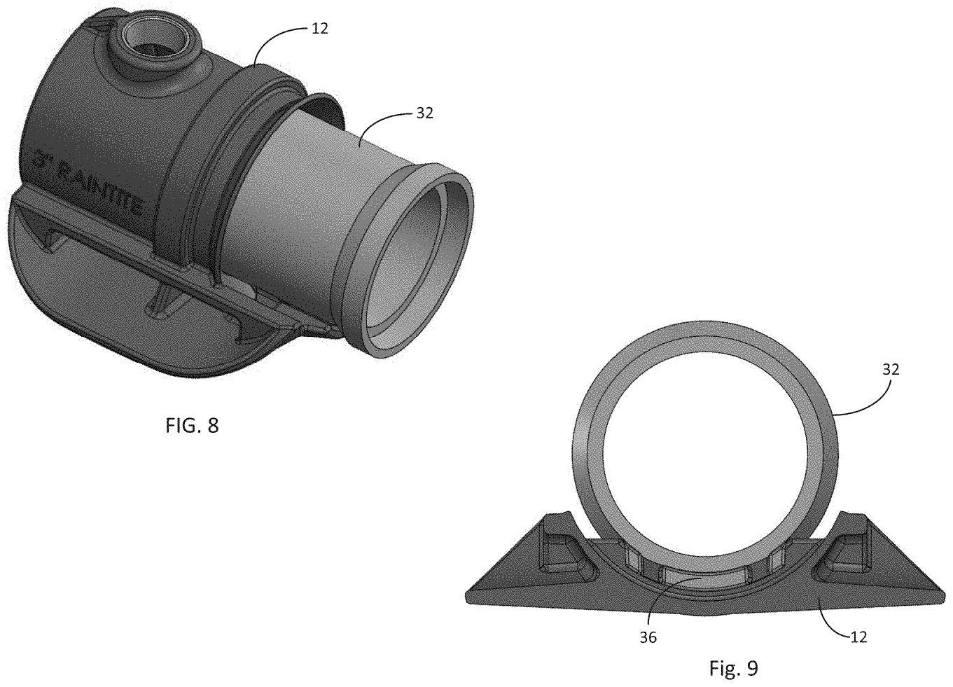

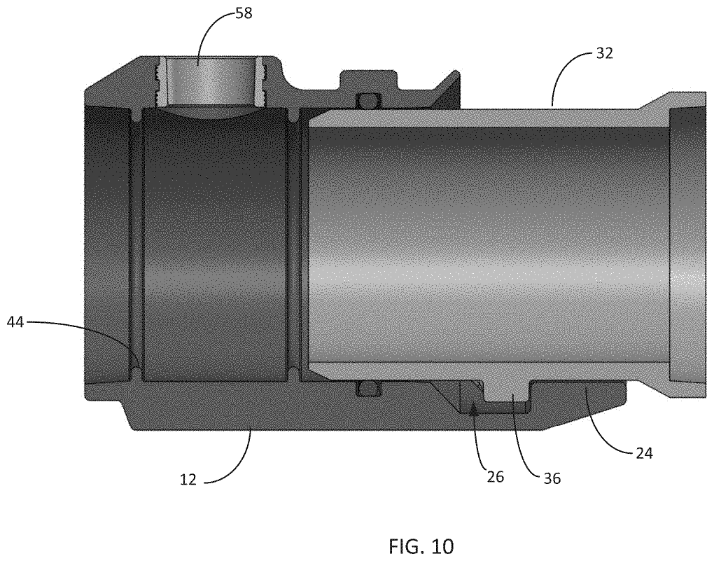

Once the tubular member 32 has been fully inserted into the bore 14 (e.g., once the first end of the tubular member contacts the backstop ring), as shown, e.g., in FIGS. 6 and 7, the retaining ring 36 may be angularly offset from the retaining pad 24 (e.g., as may be necessary to allow full insertion of the tubular member 32 into the bore 14), and the retaining ring 36 may be aligned with the channel 26 between the retaining pad 24 and the first end 16 of the bore 14. The channel 26 may be sized to at least partially receive the retaining ring 36 of the male coupling component 30. Accordingly, the male coupling component (and/or the pipe segment including the male coupling component) may be rotated relative to the female coupling component (and/or the pipe segment including the female coupling component), as indicated by the arrows in FIG. 7, to at least partially align the retaining ring 36 and the retaining pad 24. Consistent with some example embodiments, the channel 26 may be generally open on either side. Accordingly, rotation of the male coupling component relative to the female coupling component may occur in either direction. In this regard, such an embodiment may allow for bi-directional rotation to effect coupling. For example, rotating the male coupling component and the female coupling component relative to one another includes one or more of rotating the male coupling component in a clockwise direction, rotating the male coupling component in a counterclockwise direction, rotating the female coupling component in a clockwise direction, and rotating the female coupling component in a counterclockwise direction. When the retaining ring 36 is at least partially aligned with the retaining pad 24, the retaining ring 36 may be at least partially positioned within the channel 26. Once the retaining ring 36 is at least partially aligned with the retaining pad 24, the male and female coupling components (along with any pipe segments respectively associated therewith) may be coupled to one another, as shown in FIGS. 8 through 10. It should be noted that either the male coupling component, the female coupling component, or both the male coupling component and the female coupling component may be rotated to at least partially align the retaining ring 36 and the retaining pad 24. The interaction of the retaining ring 36 and the retaining pad 24 may resist removal of the tubular member from the bore. For example, and as illustrated in example embodiment shown in FIG. 10, in a coupled configuration, the tubular member 32 may be fully inserted within the bore 14 to contact the backstop ring 54. The O-ring 18 may be sealingly engaged with the exterior of the tubular member 32 to provide a generally fluid-tight seal. Further, the retaining ring 36 may be at least partially positioned in the channel 26, and may be adjacent to the retaining pad 24. In this configuration, the retaining ring 36 may interact with the retaining pad 24, such that the retaining pad 24 may restrict longitudinal movement of the retaining ring 36 and the tubular member 32 to resist separation from the female coupling component 10.

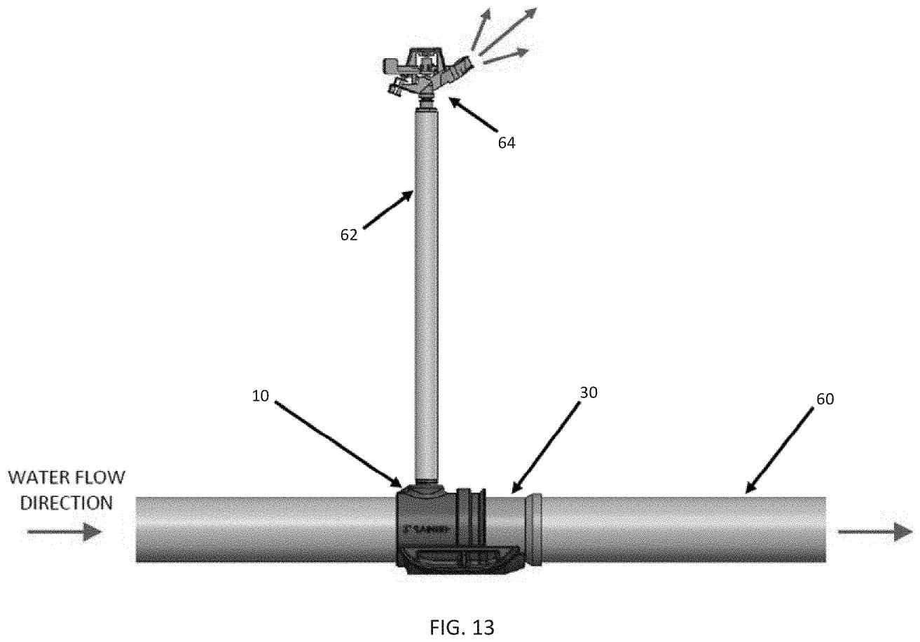

Consistent with a particular illustrative example embodiment, the coupling assembly may be used in connection with irrigation piping. For example, and referring also to FIG. 13, each of the male coupling component 30 and the female coupling component 10 may be connected to respective segments of irrigation pipe (e.g., irrigation pipe segment 60), such as three inch aluminum irrigation pipe (and/or irrigation pipe of another size and/or dimension). For example, in some embodiments, the irrigation pipe may include 30 foot segments of three inch aluminum irrigation pipe having a male coupling component welded to one end of the pipe, and a female coupling component welded to the other end of the pipe. Consistent with such an illustrative example embodiment, sections of pipe (including the coupling components) may be joined together to form a desired irrigation arrangement. For example, one pipe segment may be laid flat on the ground, with the female coupling facing in the direction where the additional pipe segment(s) will be joined. A joining pipe segment may be rotated approximately 90 degrees, either in clockwise or counterclockwise direction, prior to installation, with an example sprinkler riser assembly 62 parallel with the ground (shown oriented perpendicular to the ground in FIG. 13). The sprinkler riser assembly 62 may be attached to the coupling to regulate the direction and flow of water to the surrounding crops being irrigated, and may include, for example an impact sprinkler 64, and/or other sprinkler arrangement. The joining pipe segment may be angled at, e.g., a 2-5 degree vertical pitch (although other angles may be used for the design without departing from the scope of the disclosure), and may be at least partially inserted into the bore of the female coupling component. Once the end of the male coupling component enters the inside bore of the female coupling component, the joining pipe segment may be lowered down to be parallel with the ground. With the female coupling component restrained, the male coupling component on the joining pipe segment may be fully inserted into the female coupling until the end of the male coupling component hits the backstop ring. The O-ring may generally be for sealing, and the backstop ring may generally prevent the pipe from being inserted further into the female coupling component and/or preventing debris buildup around the O-ring. The joining pipe segment may be rotated, e.g., 90 degrees, either clockwise or counterclockwise depending on the starting position, and then pulled back until the retaining ring on the male coupling component contacts the retaining pad on the female coupling component. The retaining ring may generally be used to lock the pipe with the coupling. Disassembly may be accomplished by performing the above in the reverse order.

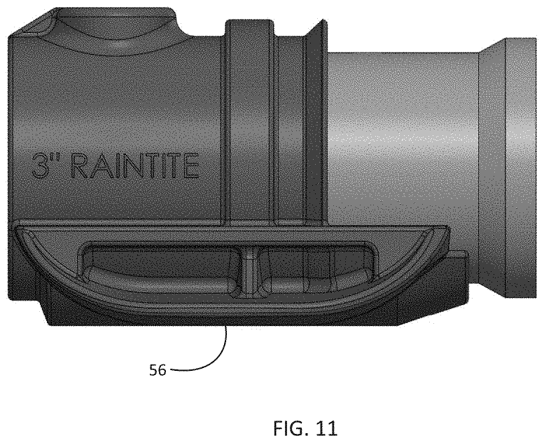

In some implementations, for example when used in connection with irrigation piping, it may be desirable to move a length of pipe including two or more coupled pipe segments. As will be appreciated, moving piping along the ground may result in the intrusion of dirt and/or other debris into the pipe joint, which may, for example, be forced into the O-ring sealing interface and/or make disassembly of the coupled pipes difficult. Consistent with an illustrative example embodiment, and with additional reference to FIG. 11, the female coupling component may include a sled feature 56, generally extending between the first end 16 of the body 12 and the second end 40 of the body. The sled feature 56 may be upturned at at least one of the first end of the body and the second end of the body. For example, as shown, the sled feature may be upturned at both the first end and the second end of the body. Further, as shown, the sled feature may extend to, and/or beyond, the forward portion of the retaining pad 24. As shown in FIG. 11, in some embodiments, the sled feature may include a curved shape between the first end of the body and the second end of the body. The relatively steep incline of the sled may help deflect dirt away from the center of the coupling component when a pipe including the coupling component is pulled across the ground. Consistent with the foregoing, coupled pipe segments may be positioned and/or moved to a desired location by dragging one or more of the pipe segments across the ground to the desired position or location. The sled feature may assist in deflecting dirt and/or debris away of the bore of the female coupling component.

In some situations, it may be desirable to provide a fluid inlet and/or outlet for a piping system. Consistent with an illustrative example embodiment, the female coupling component 10 may include a fluid passage formed in the body 12. In some embodiments, the fluid passage may include a threaded bushing 58, e.g., which may be cast and/or molded into the body 12 of the female coupling component. In some embodiments, the threaded bushing 58 may be formed of a stronger and/or harder material than the female coupling component 10. As such, the threaded bushing may provide greater durability for piping, or the like, which may be threaded into the bushing. However, it will be appreciated that in other embodiments a fluid inlet/outlet may be formed directly in the body 12 of the female coupling component, e.g., without the use of a separate bushing. In a particular embodiment, in which the coupling assembly may be used in connection with irrigation piping, the threaded bushing may include, for example, a steel ¾ inch NPT threaded bushing, e.g., which may support a sprinkler riser (e.g., sprinkler riser 62, as shown in FIG. 13). It will be appreciated that the threaded bushing may be utilized for purposed other than coupling with a sprinkler riser.

Consistent with various embodiments, the male and female coupling components may be formed from any suitable material. For example, the male and female coupling components may include cast and/or machined aluminum, steel, brass, etc. In some embodiments, the male and female coupling components may be formed from a plastic material, such as nylon, ABS, polycarbonate, acrylic, or the like, any of which may be reinforced, e.g., with fiberglass reinforcement. Additionally, the male and female coupling components may be made from more than one material (e.g., the female coupling component may include a cast-in threaded steel bushing). Further, the male and female coupling components may be formed from different materials and/or via different processes from one another.

In the preceding description of example embodiments, the male and female coupling components have generally been described as straight couplings, e.g., having a generally linear configuration with a first respective end including features for coupling with a cooperating coupling component, and with an opposed end being generally configured to be joined to a pipe, tube, or the like. However, it will be appreciated that the coupling arrangement disclosed herein may be equally applied to various other configurations. For example, one or more of the male coupling component and the female coupling component may be configure having a generally linear configuration with a first end having features for coupling with a cooperating coupling component (e.g., a female coupling component may include features for coupling with a male coupling component, and vice versa). The second end of one or more of a male coupling component and/or a female coupling component may additionally include features for coupling with an additional cooperating coupling component. For example, a coupling component may include coupling features of a female coupling component at both ends of the coupling component; may include coupling features of a female coupling component at a first end and coupling features of a male coupling component at a second end; and/or may include coupling features of a male coupling component at both ends. Additionally, in some embodiments, rather than being configured as a generally linear component, either and/or both of the male coupling component and the female coupling component may be configured as a 90 degree elbow, a 45 degree elbow, and/or another non-linear configuration, e.g., with a first end being oriented at an angle relative to a second end. Consistent with such embodiments, a first end of the coupling component (male and/or female) may include coupling features for coupling with a cooperating coupling component, and the second end of the coupling component may be configured to be joined to a pipe, tube, or the like; and/or the second end of the coupling component may include coupling features (either male or female). Similarly, the male and/or the female coupling component may have other configurations, such as a tee joint configuration, e.g., in which at least one of the three aspects of the tee joint includes coupling features of a male coupling component or a female coupling component, and the other two aspects of the tee joint may be variously configured to be joined to a pipe or tube and/or may include additional coupling features (e.g., male and/or female coupling features). Further, embodiments of the coupling components may include additional and/or alternative features, such as opening valves, bypasses, and like. Such additional features may be included with generally linear coupling components, coupling components configured as elbows, coupling components configured as tee joints, and the like. It will be appreciated that various additional and/or alternative implementations and configurations may be utilized within the context of coupling arrangements consistent with the present disclosure.

While various example embodiments have been described herein, it will be appreciated that the described embodiments are susceptible to modification and variation without departing from the spirit of the disclosure. Accordingly, the described embodiments should be understood for the purpose of illustration and not limitation. The scope of the present invention is not intended to be limited by the foregoing disclosure, and should be afforded the full scope of the claims appended hereto.

What is claimed is:

1. A pipe coupling assembly comprising:
a male coupling component comprising a tubular member having a first end and a retaining ring spaced from the first end, the retaining ring projecting radially from the tubular member and extending around a portion of the circumference of the tubular member;
a female coupling component comprising a body having:
a bore extending through the body, a first end of the bore sized to slidingly receive the first end of the tubular member;
a radial groove formed in a side wall of the bore spaced from the first end of the body;
an O-ring at least partially received in the groove, the O-ring sized to sealingly engage an exterior of the tubular member when the tubular member is received within the bore; and
a retaining pad extending outwardly relative to the bore, and spaced from the first end of the bore to define a channel between a first end of the body and the retaining pad, the channel sized to at least partially receive the retaining ring of the male coupling component.

2. The pipe coupling assembly according to claim 1, wherein one or more of the first end of the tubular member and the bore of the body include a chamfer to facilitate insertion of the tubular member into the bore.

3. The pipe coupling assembly according to claim 1, wherein the body further comprises a backstop ring defining a diameter less than an outside diameter of the tubular member to resist insertion of the tubular member into the bore beyond the backstop ring.

4. The pipe coupling assembly according to claim 1, wherein the tubular member is insertable into the bore of the body when the retaining ring is in a first angular orientation relative to the retaining pad.

5. The pipe coupling assembly according to claim 4, wherein the retaining ring is at least partially received in the channel in a second angular orientation of the retaining ring relative to the retaining pad, and wherein interaction of the retaining ring and the retaining pad resists removal of the tubular member from the bore.

6. The pipe coupling assembly according to claim 1, wherein the retaining ring includes one or more support gussets extending between a forward face of the retaining ring and the exterior of the tubular member.

7. The pipe coupling assembly according to claim 1, wherein the tubular member further comprises a second end longitudinally opposed to the first end, the second end configured to be coupled with a fluid pipe.

8. The pipe coupling assembly according to claim 7, wherein the second end of the tubular member includes a bore having an inside diameter configured for receiving an end of a pipe section.

9. The pipe coupling assembly according to claim 1, wherein the body further comprises a second end longitudinally opposed to the first end, the second end configured to be coupled with a fluid pipe.

10. The pipe coupling assembly according to claim 9, wherein the second end of the body includes a bore having an inside diameter configured for receiving an end of a pipe section.

11. The pipe coupling assembly according to claim 1, wherein the body includes a sled feature extending between a first end of the body and a second end of the body, the sled feature being upturned at at least one of the first end of the body and the second end of the body.

12. The pipe coupling assembly according to claim 11, wherein the sled feature includes a curved shape between the first end of the body and the second end of the body.

13. The pipe coupling assembly according to claim 1, wherein the body includes a threaded bushing in fluid communication with the bore and extending radially outwardly relative to the bore.

14. The pipe coupling assembly according to claim 13, wherein the threaded bushing is cast into the body.

15. A method of coupling at least two pipe segments comprising:
providing a first pipe segment coupled at one end to a male coupling component, the male coupling component comprising a tubular member having a first end and a retaining ring spaced from the first end, the retaining ring projecting radially from the tubular member and extending around a portion of the circumference of the tubular member;
providing a second pipe segment coupled at one end to a female coupling component, the female coupling component comprising a body having:
a bore extending through the body, a first end of the bore sized to slidingly receive the first end of the tubular member;
a radial groove formed in a side wall of the bore spaced from the first end of the body;
an O-ring at least partially received in the groove, the O-ring sized to sealingly engage an exterior of the tubular member when the tubular member is received within the bore; and
a retaining pad extending outwardly relative to the bore, and spaced from the first end of the bore to define a channel between a first end of the body and the retaining pad, the channel sized to at least partially receive the retaining ring of the male coupling component;
orienting the first pipe segment relative to the second pipe segment to position the retaining ring out of alignment with the retaining pad;
inserting the male coupling component at least partially into the bore of the female coupling component to sealingly engage the exterior of the tubular member with the O-ring;
rotating the first pipe segment and the second pipe segment relative to one another to at least partially align the retaining ring and the retaining pad to position the retaining ring at least partially within the channel.

16. The method according to claim 15, wherein inserting the male coupling component at least partially into the bore of the female coupling component includes inserting the tubular member into the bore until the first end of the tubular member contacts a backstop ring within the bore, the backstop ring defining a diameter less than an outside diameter of the tubular member.

17. The method according to claim 15, wherein inserting the male coupling component at least partially into the bore of the female coupling component includes one or more of:
orienting one or more of the first pipe segment and the second pipe segment generally parallel with a surface at least partially supporting one or more of the first pipe segment and the second pipe segment; and
orienting one or more of the first pipe segment and the second pipe segment at an angle relative to the surface at least partially supporting one or more of the first pipe segment and the second pipe segment.

18. The method according to claim 15, wherein the pipe segments include irrigation pipe segments.

19. The method according to claim 18, wherein the female coupling component includes a sprinkler riser extending therefrom, and wherein inserting the male coupling component at least partially into the bore of the female coupling component includes orienting the sprinkler riser generally parallel to a surface supporting at least a portion of the second pipe segment.

20. The method according to claim 15, wherein rotating the first pipe segment and the second pipe segment relative to one another includes one or more of rotating the first pipe segment in a clockwise direction, rotating the first pipe segment in a counterclockwise direction, rotating the second pipe segment in a clockwise direction, and rotating the second pipe segment in a counterclockwise direction.

21. The method according to claim 15, wherein rotating the first pipe segment and the second pipe segment relative to one another to at least partially align the retaining ring and the retaining pad to position the retaining ring at least partially within the channel couples the first pipe segment and the second pipe segment; the method further including:
positioning the coupled first pipe segment and second pipe segment in a desired location by dragging one of the first pipe segment and the second pipe segment, wherein an interaction between the retaining ring and the retaining pad resists separation of the first pipe segment and the second pipe segment.

22. The method according to claim 21, wherein the body includes a sled feature extending between a first end of the body and a second end of the body, the sled feature being upturned at at least one of the first end of the body and the second end of the body, and wherein the sled feature reduces intrusion of dirt into the bore of the body.

23. The method according to claim 22, wherein the sled feature includes a curved shape between the first end of the body and the second end of the body.
